(19) United States
(12) Patent Application Publication
(10) Pub. No.: US 2017/0075366 A1
(43) Pub. Date: Mar. 16, 2017

(54) Methods and Systems to Synchronize Vehicle Settings Via a Home Network Connection

(71) Applicant: Ford Global Technologies, LLC, Dearborn, MI (US)

(72) Inventors: Chad Evert ESSELINK, Canton, MI (US); Jason Robert BROWN, Livonia, MI (US); Rebecca Helen FARRER, Westland, MI (US)

(21) Appl. No.: 14/851,816

(22) Filed: Sep. 11, 2015

(51) Int. Cl. G05D 23/19; G01C 21/36; G07C 5/00; G05B 15/02; B60K 35/00

(52) U.S. Cl. CPC G05D 23/1917; G05B 15/02; B60K 35/00; G07C 5/008; G01C 21/36

(57) ABSTRACT

A vehicle system includes a processor programmed to synchronize a vehicle setting based on a home setting received from a home network. The processor is in communication with the home network via a transceiver. The processor is programmed to establish communication with the home network based on a vehicle start request, receive the home system setting from the home network if a vehicle location is less than a predefined distance, and synchronize one or more vehicle settings based on the home system setting.

### TECHNICAL FIELD

The present disclosure generally relates to vehicle infotainment systems, and more particularly, to customizing the vehicle infotainment systems.

### BACKGROUND

A vehicle infotainment system is used to provide several features and functions including hands-free calling, navigation information and music to an occupant while traveling to a destination. The vehicle infotainment system provides settings to allow configuration of the features and functions based on an occupant's preference. The settings may be manually configured once the occupant enters the vehicle. For example, the vehicle infotainment system may be configured to adjust climate control settings at the vehicle. The climate control settings may be initiated using physically-actuated inputs carried by the vehicle and manipulated by the vehicle occupant.

The vehicle infotainment system may receive additional features and functions from a remote network and/or a connected device such as a smartphone provided by an occupant. For example, these features and functions have included fitness, music, and navigation applications. The connected device features and functions may be integrated with the vehicle infotainment system. The remote network and/or connected device communicating with the vehicle infotainment system may bring the additional features and functions to the vehicle occupant. The settings for the vehicle infotainment system features and functions may be adjusted at the vehicle infotainment system.

### SUMMARY

In at least one embodiment, a vehicle system includes a processor programmed to synchronize a vehicle setting based on a home setting received from a home network. The processor is in communication with the home network via a transceiver. The processor is programmed to establish communication with the home network based on a vehicle start request, receive the home system setting from the home network if a vehicle location is less than a predefined distance, and synchronize one or more vehicle settings based on the home system setting.

In at least one embodiment, a home network synchronization method for adjusting a vehicle infotainment setting based on a current setting of one or more home devices in communication with a vehicle processor includes comparing a vehicle location to a predefined home distance based on a vehicle start request and receiving current settings associated with the one or more home devices at the vehicle processor if the vehicle location is within the predefined home distance. The method further includes synchronizing, via the vehicle processor, one or more infotainment settings based on the current settings of the one or more home devices.

In at least one embodiment, a computer-program product embodied in a non-transitory computer readable medium having instructions for a processor programmed for synchronizing a home system based on a vehicle setting if a vehicle is within a predefined distance. The computer-program product includes further instructions for receiving the vehicle setting based on communication with a vehicle processor, generating a configuration message for a home system based on the vehicle setting, transmitting the configuration message to the home system, and communicating a confirmation message to the vehicle processor based on synchronization of the home system.

### BRIEF DESCRIPTION OF THE DRAWINGS

FIG. 1 is a representative topology of a vehicle computing system implementing a user-interactive vehicle information display system according to an embodiment;

FIG. 2 is a representative block topology of the vehicle computing system communicating with a home network according to an embodiment;

FIG. 3 is a representative block topology of the vehicle computing system communicating with one or more home devices via the home network according to an embodiment;

FIG. 4 is a flow chart illustrating an example method of the vehicle computing system configuring a vehicle feature based on the synchronization of data received from the home network according to an embodiment;

FIG. 5 is a flow chart illustrating an example method of the home network generating a notification message to the vehicle computing system based on information received from one or more home devices according to an embodiment; and

FIG. 6 is a flow chart illustrating an example method of the vehicle computing system synchronizing settings based on a home device according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

The disclosure relates to concepts relating to synchronization of one or more settings between a vehicle computing system and a home network. The vehicle computing system may include one or more settings for features and functions of an infotainment system. The home network may include one or more settings associated with an appliance or home system. In response to a communication connection with a home network, the vehicle computing system may compare a current vehicle location to a first predefined distance. If the vehicle computing system determines that the current vehicle location is within the first predefined distance, the system may synchronize one or more infotainment settings based on setting information received from the appliance or home system associated with the home network.

For example, the home network may communicate to the vehicle computing system based on the vehicle location being within the first predefined distance. In response to the vehicle computing system receiving data from the home network, the system may generate one or more vehicle commands for the infotainment settings. The one or more vehicle commands include, but are not limited to, generate a deactivation message for an appliance (turnoff an oven left on, for example) based on a vehicle departure, synchronize vehicle lighting and/or temperature settings based on received home settings, synchronize a vehicle radio based on a received home television, radio station being played in the home and/or media setting, and/or synchronize a vehicle navigation system based on a received task list.

The home network may synchronize one or more home settings if the current vehicle location is within a second predefined distance. For example, the vehicle computing system may communicate to the home network that an incoming driver is on her way home based on the vehicle location being within the second predefined distance. In response to the home network receiving data from the vehicle computing system, the home network may generate one or more commands for the appliance and/or home system. The one or more commands may include, but are not limited to, activate an appliance (preheat an oven, for example), synchronize home lighting and/or temperature settings based on a vehicle setting, adjust a window blind state, synchronize home media (television, radio, etc., for example) based on a vehicle setting, and/or alert a home occupant via a display (television, for example) that the driver is arriving.

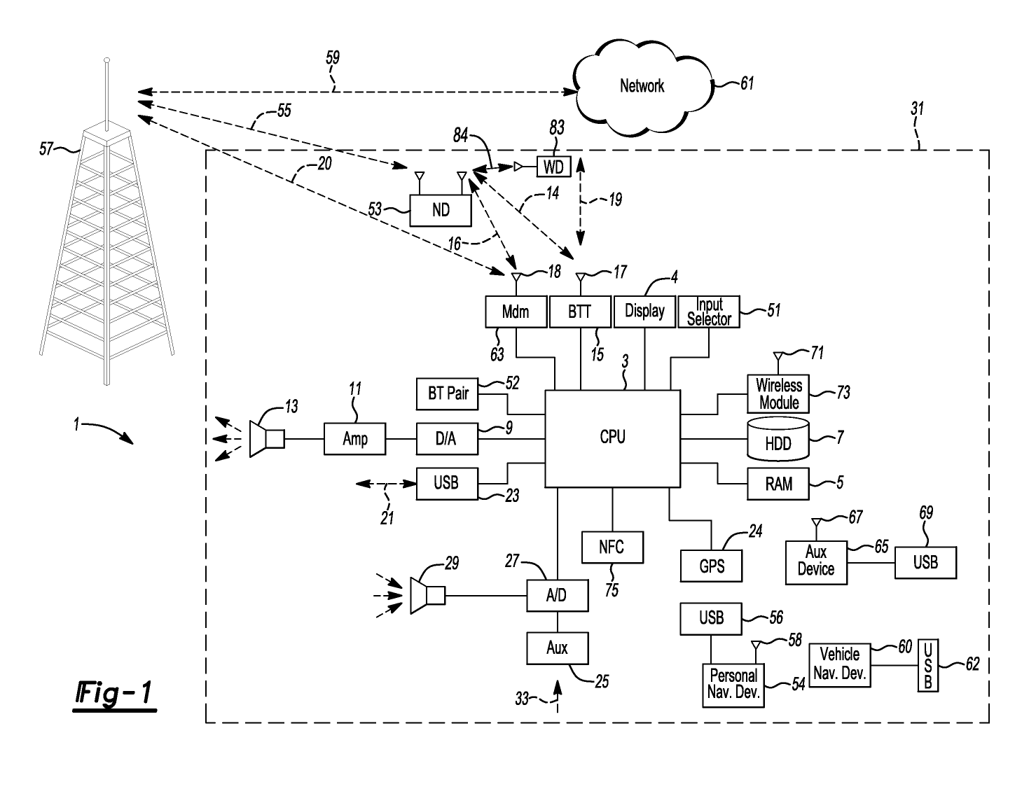

FIG. 1 illustrates an example block topology for the VCS 1 for a vehicle 31. An example of such a VCS 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor 3 is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor 3 is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous vehicle components and auxiliary components in communication with the VCS 1 may use a vehicle network (such as, but not limited to, a CAN bus) to pass data to and from the VCS 1 (or components thereof).

Outputs to the system may include, but are not limited to, a visual display 4 and a speaker 13 or stereo system output. The speaker 13 is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (cell phone, smart phone, PDA, or any other device having wireless remote network connectivity, for example). The nomadic device 53 can then be used to communicate 59 with a network 61 outside the vehicle 31 through, for example, communication 55 with a cellular tower 57. In some embodiments, tower 57 may be a WiFi access point. The nomadic device 53 may also be used to communicate 84 with an accessory device such as a wearable device 83 (smartwatch, smart glasses, etc., for example). The nomadic device 53 may communicate 84 one or more control functions to the wearable device 83. For example, the nomadic device 53 may enable the wearable device 83 to accept a phone call, enable a mobile application, receive notifications, and/or a combination thereof In another example, the wearable device 83 may transmit vehicle control features/functions to the VCS 1 based on one or more mobile applications executed at the nomadic device 53.

Communication between the nomadic device 53 and the BLUETOOTH transceiver is represented by signal 14. Pairing a nomadic device 53 and the BLUETOOTH transceiver 15 can be instructed through a button 52 or similar input. Accordingly, the CPU 3 is instructed so that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having an antenna 18 in order to communicate 16 data between CPU 3 and network 61 over the voice band. The nomadic device 53 may then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

For example, the network 61 may include a home network having one or more home devices. The home network may communicate data associated with the one or more home devices to the CPU 3 using wireless communication. The data may include, but is not limited to, settings for the one or more home devices.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, the nomadic device 53 includes a modem for voice band or broadband data communication. In the data-over-voice embodiment, a technique known as frequency division multiplexing may be implemented when the owner of the nomadic device 53 can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device 53, it is possible that the data- plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11 g network (i.e., WiFi) or a WiMax network.

In one embodiment, incoming data can be passed through the nomadic device 53 via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU 3 could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU 3 could be connected to a vehicle based wireless router 73, using for example a WiFi (IEEE 803.11) 71 transceiver. This could allow the CPU 3 to connect to remote networks in range of the local router 73.

In addition to having representative processes executed by a VCS 1 located in a vehicle, in certain embodiments, the processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process includes sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the processes.

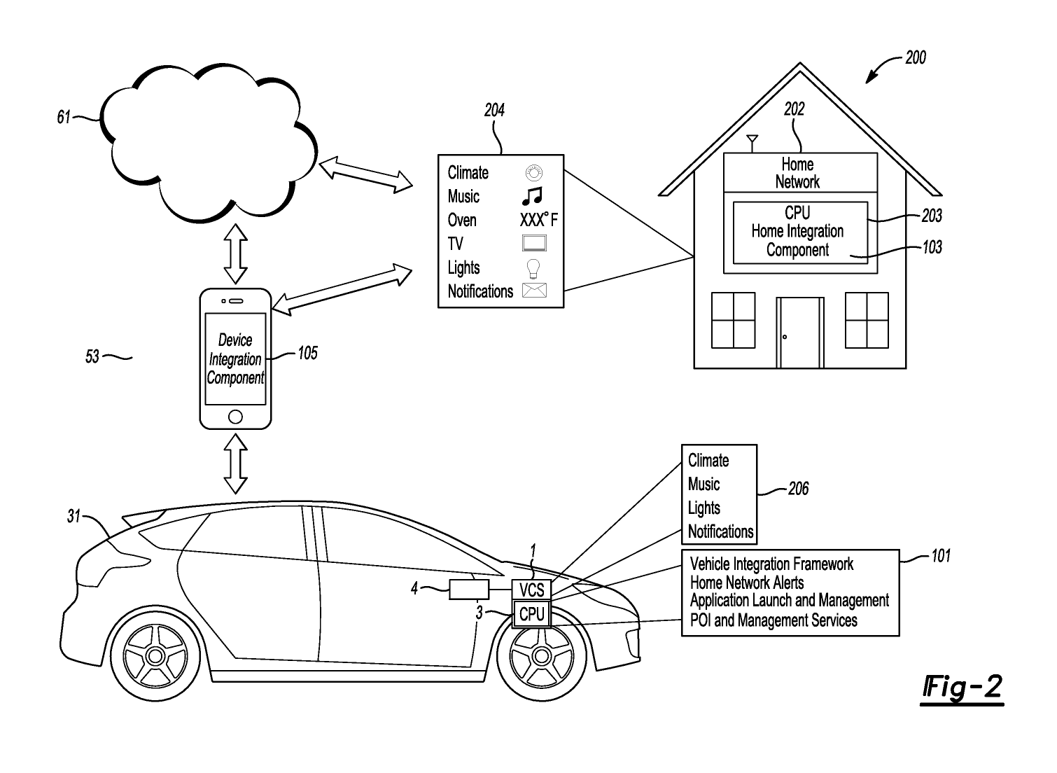

FIG. 2 is a representative block topology 200 of the VCS 1 communicating with a home network 202 according to an embodiment. The VCS 1 may be in communication with one or more transceivers. The one or more transceivers are capable of wired and wireless communication to receive signals associated with settings of a home device (an appliance, a climate system, etc. for example). The VCS 1 may synchronize one or more infotainment settings 206 based on setting(s) of the home appliance and/or home system 204 connected to the home network 202. To facilitate the integration, the VCS 1 may include a vehicle integration framework 101 executed at the CPU 3 and configured to provide various services to the VCS 1. These services may include transport routing of messages between the home network 202 and the VCS 1, synchronization of one or more infotainment settings 206 based on settings 204 at the home network 202, notification services to allow the VCS 1 to receive and provide home network alerts, application launch and management facilities to allow for unified access to applications executed by the CPU 3 and those executed by a processor at the home network 202, and point of interest location and management services for synchronization of a vehicle navigation system based on a home errand list generated by the home network 202.

As mentioned above, the CPU 3 of the VCS 1 may be configured to interface with one or more appliances of various types in communication with the home network 202. The home network 202 may further include a home integration client component 103 to allow the home network 202 to take advantage of the services provided by the vehicle integration framework 101. The home integration client component 103 may be referred to as an application. The application is executed on hardware (a processor 203, for example) at the home network 202. The application may communicate data from the home network 202 to the VCS 1 via the transceiver.

The home network 202 may communicate application data with a nomadic device 53 via wireless technology. The wireless technology may include Bluetooth Low Energy (BLE). In another example, the home network may communicate to the nomadic device 53 via a network 61 connection. The VCS 1 and home network 202 may establish communication via the nomadic device 53. The nomadic device 53 may receive application data executed at the home network 202 using a nomadic device integration component 105. The nomadic device integration component 105 may allow the nomadic device 53 to take advantage of the services provided by the vehicle integration framework 101 and the home integration client component 103. For example, the nomadic device 53 may receive vehicle data including one or more infotainment settings 206 for the vehicle infotainment system. The nomadic device 53 may transmit the received vehicle infotainment settings 206 to the home network 202. In one example, the nomadic device 53 may receive a request to synchronize the vehicle infotainment system based a received home setting 204 via the home network 202. The nomadic device 53 may transmit the synchronization request to the CPU 3.

The one or more transceivers may include a multiport connector hub. The multiport connector hub may be used to interface between the home network 202 and additional types of home devices (connected appliances and home systems, for example). The multiport connector hub may communicate with the processor 203 at the home network 202 over various buses and protocols, such as via USB, and may further communicate with the connected appliances using various other connection buses and protocols, such as Serial Peripheral Interface Bus (SPI), Inter-integrated circuit (I2C), and/or Universal Asynchronous Receiver/Transmitter (UART). The multiport connector hub may further perform communication protocol translation and interworking services between the protocols used by the connected appliances and the protocol used between the multiport connector hub and the home network processor 203. The communication protocol translation and interworking services may enable the connected appliances (home devices, for example) to communicate data to the VCS 1. The connected appliances may include, as some non-limiting examples, a stove oven, thermostat, a television, lighting system, an entertainment system, and a personal computer. In one example, the personal computer may comprise calendar information associated with an occupant of the home. The personal computer may be update periodically to receive calendar information for the occupant.

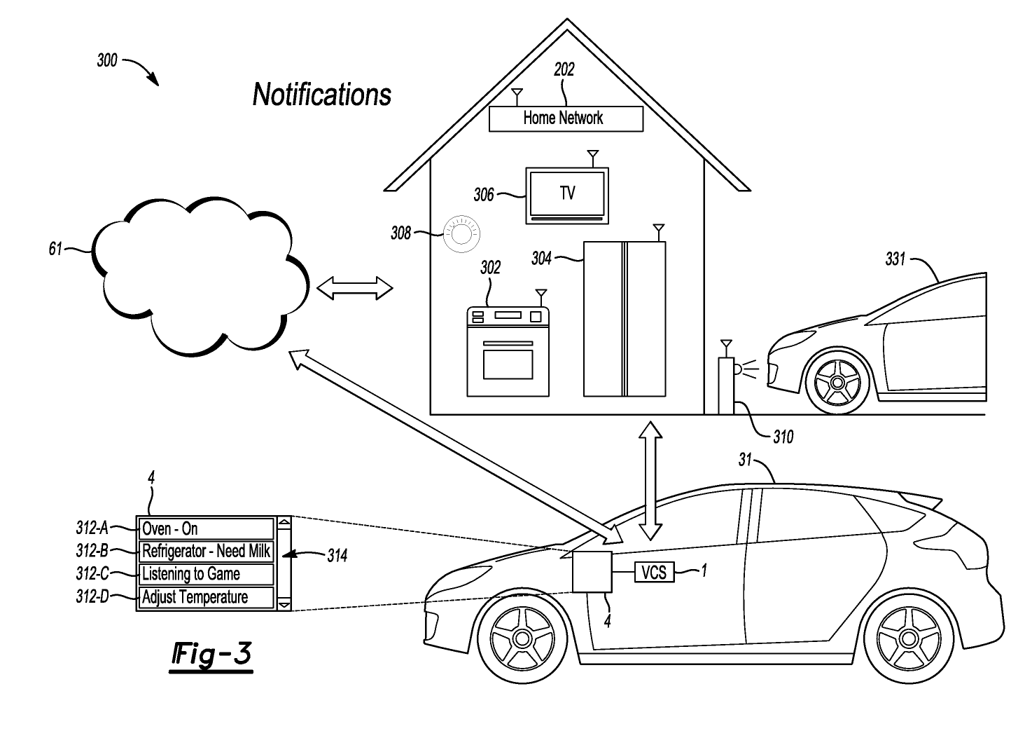

FIG. 3 is a representative block topology 300 of the VCS 1 communicating with one or more home devices via the home network 202 according to an embodiment. The one or more home devices may include, but is not limited to, a range oven 302, a refrigerator 304, a television 306, a thermostat 308, and a park detection system 310. The home network 202 may communicate with the one or more home devices. For example, the home network 202 may receive settings from the range oven 302, television 306, and thermostat 308. In another example, the home network 202 may receive status notifications from the range oven 302, refrigerator 304, and the parking detection system 310.

The home network system 202 may transmit the settings and/or notifications from the home devices to the VCS 1. For example, if a vehicle location is within the first predefined distance during a key-on event, the VCS 1 may request data and status notifications from the home devices. The first predefined distance may be a distance value that is calibrated so that the VCS 1 may recognize that the vehicle is located near the home network 202. In another example, the first predefined distance is a distance value calibrated so that the VCS 1 detects the vehicle being located in a home driveway associated with the home network 202. In response to the key-on event and the vehicle being within the first predefined distance, the VCS 1 may synchronize one or more infotainment settings based on the data and status notification from the one or more home devices.

For example, the VCS 1 may output one or more notifications at the display 4 based on data received from the home network 202. The one or more notifications may be presented at the touchscreen display 4 and may include a list control 314 configured to display selectable list entries 312-A through 312-D (collectively 312) of the home network notifications based on the home devices. The VCS 1 may enable the occupant to scroll through each of the selectable list entries 312 based on data received from the home network.

As illustrated in FIG. 3, the selectable list 314 of home network notifications includes an entry 312-A for receiving a status for the range oven 302, an entry 312-B for receiving notifications from the refrigerator 304, an entry 312-C for synchronizing the radio based on data from the television 306, and an entry 312-D to synchronize the climate control settings based on data from the thermostat 308. The list control 314 may operate as a menu, such that an occupant may scroll through the list entries of the list control 314 (using up and down arrow buttons and a select button to invoke the selected menu items, for example).

In one example, the VCS 1 may be configured to automatically synchronize the one or more infotainment settings based on the data received from the home network 202. In response to the occupant selecting the range oven entry 312-A, the VCS 1 may receive status notification for the range oven 302. If the range oven is on, the VCS 1 may allow the occupant to transmit a turn off oven message to the range oven 302 based on an established communication connection with the home network 202. In another example, in response to the selected refrigerator entry 312-B, the VCS 1 may receive a grocery list from the refrigerator 304. The VCS 1 may synchronize the navigation system to one or more destinations based on the grocery list (errand list, for example). The VCS 1 may configure one or more infotainment settings to transition an occupant from leaving the home via the vehicle. In another example, in response to a vehicle occupant arriving home, the home system may synchronize settings for one or more home devices based on vehicle infotainment settings.

For example, the VCS 1 may calculate that the vehicle location is within a second predefined distance to the home network 202. The second predefined distance is a value calibrated so that the home network 202 may recognize if the vehicle is traveling towards the home. The second predefined distance is a distance value greater than the first predefined distance. In response to the vehicle location being within the second predefined distance, the VCS 1 may generate one or more messages to synchronize home settings 204 based on the one or more infotainment settings 206. In one example, the VCS 1 may transmit a vehicle temperature setting to the home thermostat 308 via the home network 202. The home network 202 may synchronize the vehicle setting by commanding the thermostat 308 to the vehicle temperature setting. In another example, the VCS 1 may transmit a media channel being broadcasted at the infotainment system to the home network 202. The home network 202 may synchronize the vehicle setting by commanding a media system (television 306, for example) to a channel associated with the media channel being broadcasted in the vehicle.

The VCS 1 may transmit one or more notification messages to the home network 202. For example, in response to the vehicle location being within the second predefined distance, the VCS 1 may transmit a parking spot message to the home network 202. The home network 202 may determine if a parked vehicle 331 is in the parking spot via the parking detection system 310. If the home network 202 detects the parked vehicle 331 in the parking spot via the parking detection system 310, the network 202 may generate a message to notify a home occupant to move the parked vehicle 331. The message to notify the home occupant may be outputted to one or more devices including, but not limited to, the television 306. The home network 202 may transmit a message to the VCS 1 indicating whether a parking spot is available based on the data from the parking detection system 310.

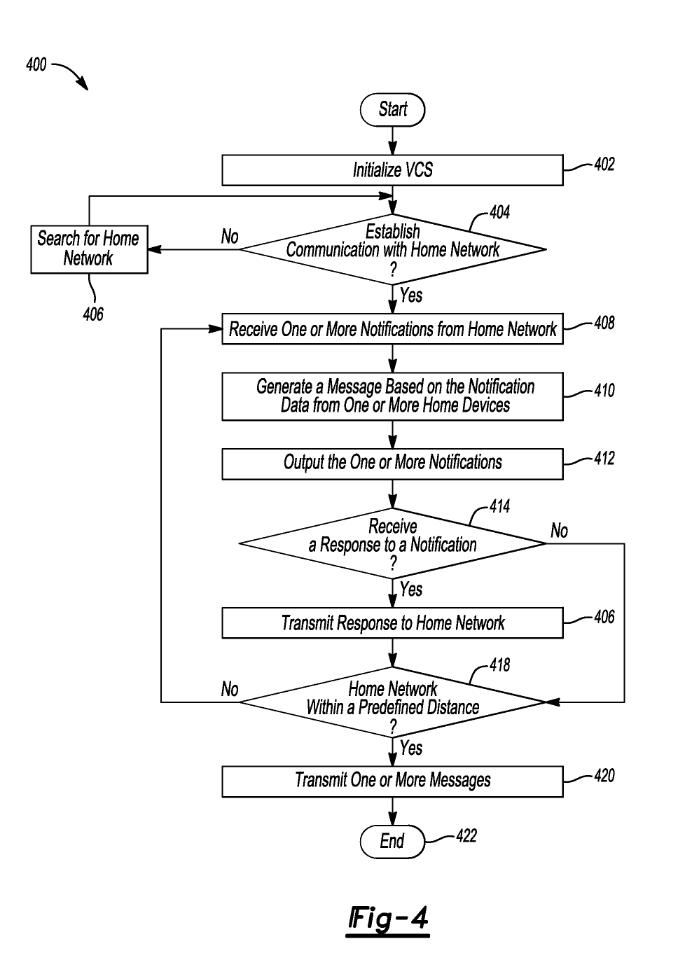

FIG. 4 is a flow chart illustrating an example method 400 of the VCS 1 configuring a vehicle feature based on the synchronization of data received from the home network 202 according to an embodiment. The method 400 may be implemented using software code contained within the VCS 1, home network 202, nomadic device 53, and/or a combination thereof.

Referring again to FIG. 4, the vehicle 31 and its components illustrated in FIG. 1, FIG. 2, and FIG. 3 are referenced throughout the description of the method 400 to facilitate understanding of various aspects of the present disclosure. The method 400 of synchronizing vehicle settings based on a setting of a home device may be implemented through a computer algorithm, machine executable code, or software instructions programmed into a suitable programmable logic device(s) of the vehicle, such as the CPU 3, the nomadic device control module, a home processor 203, another controller in communication with the vehicle computing system, or a combination thereof. Although the various operations shown in the flowchart diagram 400 appear to occur in a chronological sequence, at least some of the operations may occur in a different order, and some operations may be performed concurrently or not at all.

In operation 402, the VCS 1 may be initialized and enabled based on a key-on position or state of an ignition system. The VCS 1 may initialize one or more applications for execution. In response to the initialization of the VCS 1, the system may display the one or more applications at a user interface. For example, the VCS 1 may execute a home synchronization application via the vehicle integration framework. The home synchronization application may communicate with one or more home devices via the home network 202.

In operation 404, the VCS 1 may establish communication with the home network 202. In response to a recognized home network not previously paired with the system, the VCS 1 may provide instructions to the occupant to pair the network 202. The VCS 1 may search for a home network 202 if a network is not connected to the VCS 1 in operation 406.

In operation 408, the VCS 1 may receive one or more notifications from a home network 202. The notifications may include, but is not limited to, data associated with a range oven, television, thermostat, refrigerator, parking sensor, and/or a combination thereof. The VCS 1 may generate a message based on the notification data from the one or more home devices in operation 410.

In operation 412, the VCS 1 may output the one or more notifications at a vehicle display. For example, in response to the notification received from a refrigerator via the home network 202, the VCS 1 may output a grocery list based on the notification data. The grocery list may include one or more grocery items associated with a store location. The VCS 1 may generate a navigation route via a navigation system based on the store location associated with the one or more grocery items.

In operation 414, in response to the one or more notifications, a vehicle occupant may select a notification to synchronize a vehicle setting. The VCS 1 may transmit a response to the home network 202 based on the selected notification. Continuing from the example above, in response to the vehicle occupant selecting the store location via the vehicle display to purchase the one or more grocery items, the VCS 1 may transmit a response to the home network 202 that the vehicle occupant is in route to purchase the grocery item(s).

In operation 418, the VCS 1 may determine if the vehicle location is within a predefined distance of the home network 202. In response to the vehicle being within the predefined distance, the VCS 1 may transmit one or more infotainment settings to the home network for synchronization of home settings for one or more home devices in operation 420. The VCS 1 may end the method 400 of synchronization of one or more infotainment and home settings if the home network is no longer within the predefined distance and/or a key-off position of the ignition system is detected in operation 422.

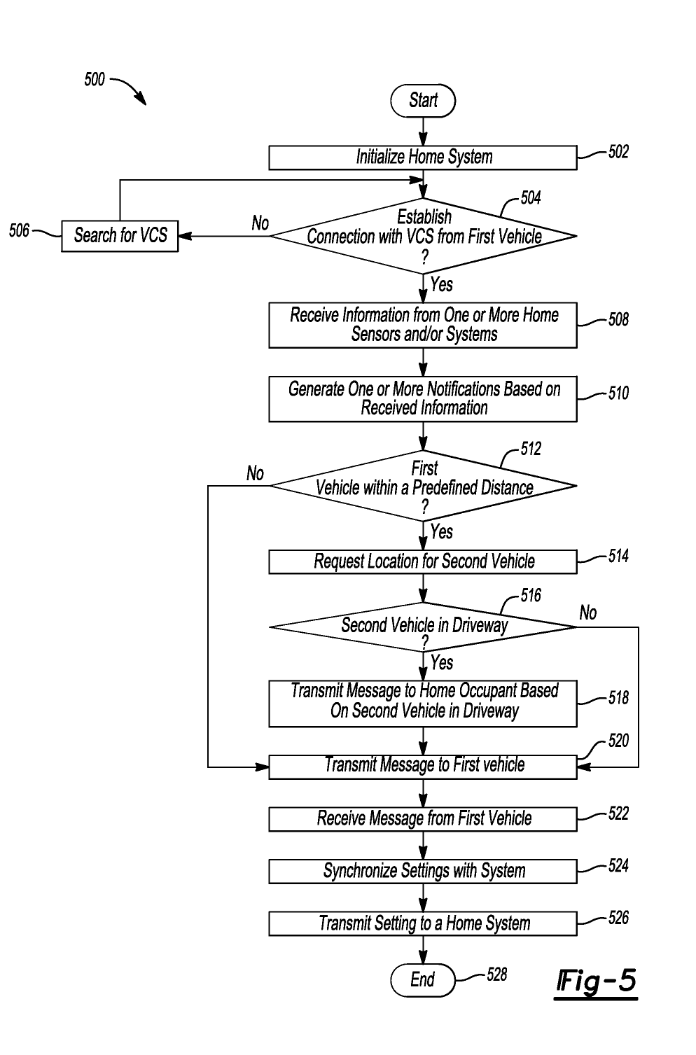

FIG. 5 is a flow chart illustrating an example method 500 of the home network 202 generating a notification message to the VCS 1 based on information received from one or more home devices according to an embodiment. The method 500 may be implemented using software code contained within the home network processor 203, VCS 1, nomadic device 53, and/or a combination thereof. The method 500 of synchronizing a home device setting based on a vehicle infotainment setting may be implemented through a computer algorithm, machine executable code, or software instructions programmed into a suitable programmable logic device(s) of the home network, such as the home processor 203, the vehicle processor 3, nomadic device processor, another controller in communication with the home network, and/or a combination thereof. The various operations shown in the flowchart diagram 500 appear to occur in a chronological sequence, at least some of the operations may occur in a different order, and some operation may be performed concurrently or not at all.

In operation 502, the home network 202 may be initialized and enabled based on a turn-on request or state of a home operating system. The home network 202 may initialize one or more applications for execution. In response to the initialization of the home network 202, the network may communicate with one or more home devices. The home devices may include, but is not limited to, home sensors or systems associated with appliances.

In operation 504, the home network 202 may establish a connection with a VCS 1 from a first vehicle. The home network 202 may search for a vehicle if a VCS 1 is not connected to the network in operation 506. In response to the established communication with the first vehicle, the home network 202 may receive information from one or more home sensors and/or systems in operation 508.

In operation 510, the home network 202 may generate one or more notification messages based on the received information. For example, the notification messages may be based on thermostat settings, music, range oven status, television channel selection, lighting settings, and/or a combination thereof.

In operation 512, the home network 202 may determine whether the first vehicle is within a predefined distance of the network. In response to the first vehicle being with the predefined distance, the home network 202 may request a location for a second vehicle in operation 514. The home network 202 may determine whether the second vehicle is in the driveway via a parking sensor in operation 516.

In operation 518, in response to the second vehicle being in the driveway, the home network 202 may transmit a message to a home occupant via one or more home devices to move the second vehicle out of the driveway. For example, the home network 202 may transmit a message to a home network display (television, for example) to notify a home occupant to move the second vehicle. In another example, the home network 202 may transmit a message to a mobile device paired to the second vehicle to move the second vehicle based on the first vehicle being within the predefined distance.

In operation 520, the home network 202 may transmit one or more messages to the first vehicle. The one or more messages may include, but is not limited to, appliance status, lighting style, parking detection, and/or home media settings. In response to the transmitted messages to the VCS 1 of the first vehicle, the home network 202 may receive a message requesting synchronization of at least one setting for the one or more home devices in operation 522.

In operation 524, the home network 202 may synchronize a setting of a home device to the at least one setting received from the VCS 1. For example, the VCS 1 may transmit to the home network 202 a lighting style mood currently implemented at the vehicle. The lighting style mood may include, but is not limited to, turning on or off a light, adjusting intensity of the light, setting a color for the light, and/or a combination thereof. The home network 202 may synchronize a home lighting system to the vehicle lighting style mood settings.

In operation 526, the home network 202 may transmit the synchronized setting to the associated home device (home lighting system, for example). Continuing from the home lighting system example above, the home network 202 may command the home lighting system to adjust the one or more settings based on the synchronized setting to match the lighting mood of the first vehicle. The home network 202 may end the method 500 of synchronizing the one or more home settings if the vehicle is no longer within the predefined distance in operation 528.

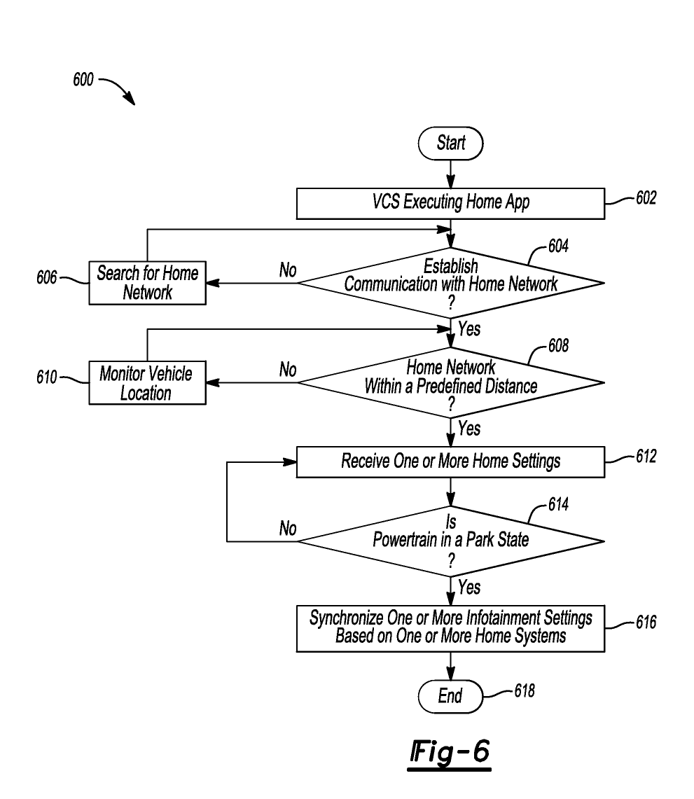

FIG. 6 is a flow chart illustrating an example method 600 of the VCS 1 synchronizing settings based on a home device according to an embodiment. The method 600 may be implemented using software code contained within the nomadic device, wearable device, VCS, and a combination thereof

Referring again to FIG. 6, the vehicle and its components illustrated in FIG. 1, FIG. 2, and FIG. 3 are referenced throughout the description of the method 600 to facilitate understanding of various aspects of the present disclosure. The method 600 of configuring the VCS 1 based on current settings of one or more home devices may be implemented through a computer algorithm, machine executable code, or software instructions programmed into a suitable programmable logic device(s) of the vehicle, such as the vehicle control module, the nomadic device control module, another controller in communication with the vehicle computing system, or a combination thereof. Although the various operations shown in the flowchart diagram 600 appear to occur in a chronological sequence, at least some of the operations may occur in a different order, and some operations may be performed concurrently or not at all.

In operation 602, the VCS 1 may be initialized and enabled based on a key-on position or state of an ignition system. The VCS 1 may initialize one or more applications for execution. In response to the initialization of the VCS 1, the system may display the one or more applications at a user interface. For example, the VCS 1 may execute a home application configured to establish communicate with the home network.

In operation 604, the VCS 1 may recognized and establish communication with the home network 202. In response to the home network 202 not connected to the VCS 1, the system may search for the home network 202 in operation 606.

In operation 608, the VCS 1 may determine if the home network 202 is within a predefined distance of the vehicle. In response to the home network 202 being within the predefined distance, the VCS 1 may receive one or more home settings in operation 612. For example, the one or more home settings may include, but is not limited to, refrigerator, thermostat, television, stove, light and radio information and settings.

In operation 614, the VCS 1 may check whether the vehicle powertrain system is in a PARK state. In response to the vehicle powertrain system being in the PARK state, the system may synchronize one or more infotainment settings based on the one or more home settings in operation 616. If the vehicle powertrain system is not in the PARK state, the VCS 1 may continue to receive updated home settings. The VCS 1 may continue to monitor the PARK state to determine if the synchronization of one or more infotainment settings may be initiated. The VCS 1 may end the method of synchronizing the one or more infotainment settings if the home network is no longer within the predefined distance and/or a key-off position of the ignition system is detected in operation 618.

While representative embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle system comprising:
a vehicle processor configured with a transceiver and programmed to, in response to a vehicle start request, establish communication with a home network via the transceiver;
if a vehicle location is less than a predefined distance, receive a home system setting from the home network; and
synchronize one or more vehicle settings based on the home system setting.

2. The vehicle system of claim 1, wherein the vehicle processor is further programmed to synchronize a radio setting as being the one or more vehicle settings to a radio station based on the home system setting being a television channel associated with the radio station.

3. The vehicle system of claim 2, wherein the vehicle processor is further programmed to synchronize a heating and air conditioning setting as being the one or more vehicle settings to a temperature value based on the home system setting being a house temperature setting.

4. The vehicle system of claim 1, wherein the predefined distance is a range value associated with a distance between a home location having the home network to the vehicle location.

5. The vehicle system of claim 1, wherein the home system setting is at least one of climate settings, music selection, television selection, light adjustment, and appliance notification.

6. The vehicle system of claim 5, wherein the appliance notification is a grocery reminder from a smart refrigerator.

7. The vehicle system of claim 6, wherein the processor is further programmed to output a grocery notification via a vehicle display as being the one or more vehicle settings based on the grocery reminder.

8. The vehicle system of claim 1, wherein the home network is configured to communicate with one or more appliance sensors and systems.

9. The vehicle system of claim 8, wherein the one or more appliance sensors and systems is at least one of a refrigerator, thermostat, television, stove, light, and radio.

10. The vehicle system of claim 1, wherein the processor is further programmed to generate one or more messages for the home network based on vehicle data.

11. The vehicle system of claim 10, wherein the processor is further programmed to transmit the vehicle data to the home network based on the predefined distance.

12. The vehicle system of claim 11, wherein the vehicle data is a home arrival notification.

13. The vehicle system of claim 11, wherein the vehicle data is at least one of a radio setting, climate setting, vehicle location and light setting.

14. A home network synchronization method comprising:
comparing a vehicle location to a predefined home distance based on a vehicle start request;
in response to the vehicle location being within the predefined home distance, receiving current settings associated with one or more home devices via a home network; and
synchronizing, via a vehicle processor, one or more infotainment settings based on the current settings of the one or more home devices.

15. The method of claim 14, further comprising synchronizing the one or more infotainment settings to a radio station based on the received current settings being a radio broadcast channel.

16. The method of claim 14, further comprising synchronizing a navigation system as being the one or more infotainment settings based on the received current settings being an errand list having a task associated with an address and outputting a route at a vehicle display based on the address via the navigation system.

17. The method of claim 16, wherein the errand list is generated at the home network based on received input from at least one sensor and system at the one or more home devices.

18. A computer-program product embodied in a non-transitory computer readable medium having stored instructions for programming a processor, comprising instructions for:
in response to communication with a vehicle processor, receiving a vehicle setting;
generating a configuration message for a home system based on the vehicle setting;
transmitting the configuration message to the home system; and
in response to synchronization of the home system based on the configuration message, transmitting a confirmation message to the vehicle processor.

19. The computer-program product of claim 18, wherein the non-transitory computer readable medium further comprises instructions for:
synchronizing the home system to a climate setting based on the vehicle setting being a temperature value associated with the climate setting.

20. The computer program product of claim 18, wherein the confirmation message is configured to output at a vehicle display verifying that the configuration message was received by the home system.
